(19) United States
(12) Patent Application Publication
(10) Pub. No.: US 2011/0189570 A1
(43) Pub. Date: Aug. 4, 2011

(54) SYSTEM AND METHOD FOR PASSIVATING A FUEL CELL POWER PLANT

(75) Inventor: Michael L. Perry, Glastonbury, CT (US)

(73) Assignee: UTC POWER CORPORATION, South Windsor, CT (US)

(21) Appl. No.: 13/059,567

(22) PCT Filed: Oct. 21, 2008
(86) PCT No.: PCT/US08/11952

§ 371 Date: Feb. 17, 2011

(51) Int. Cl. H01M 8/04

(52) U.S. Cl. 429/429

(57) ABSTRACT

A system and method for passivating a fuel cell power plant 10 with hydrogen fuel utilizes a fuel blower 10 to assist in circulating fuel between a fuel processing system 38 and air processing system 12 via an inlet transfer line 66 connecting fuel feed line 42 and air feed line 18, as well as an outlet transfer line 60 connecting a fuel outlet line 56 to an air outlet line 36, and does not require the use of a combustible gas fuel certified air blower.

### BACKGROUND

The present disclosure relates in general to the management of reactants in fuel cell power plants, and more particularly, to a hydrogen passivation system and method that minimizes performance degradation of fuel cells of the plant.

Fuel cell power plants are well known for converting chemical energy into usable electrical power, and have applications ranging from stationary power plants to automotives. Fuel cell power plants usually comprise multiple fuel cells arranged in a repeating fashion to form a cell stack assembly (“CSA”), including internal ports or external manifolds connecting coolant fluid and reactant gas flow passages or channels. Each individual fuel cell typically includes an electrolyte membrane (e.g., a proton exchange membrane) sandwiched between an anode electrode catalyst and a cathode electrode catalyst to form a membrane electrode assembly. On either side of the membrane electrode assembly are gas diffusion layers in contact with bipolar plates that comprise reactant flow fields for supplying a reactant fuel (e.g., hydrogen) to the anode, and a reactant oxidant (e.g., oxygen or air) to the cathode, the reactants diffusing through the gas diffusion layers to be evenly distributed on the anode or cathode catalyst. The hydrogen electrochemically reacts with the anode catalyst of the proton exchange membrane to produce positively charged hydrogen protons and negatively charged electrons. The electrolyte membrane only allows the hydrogen protons to transfer through to the cathode side of the membrane, forcing the electrons to follow an external path through a circuit to power a load before being conducted to the cathode catalyst. When the hydrogen protons and electrons eventually come together at the cathode catalyst, they combine with the oxidant to produce water and thermal energy. Due to the conductive nature of the fuel cell subcomponents, including the membrane electrode assembly and the bipolar plates, multiple fuel cells may be stacked together in electrical series to increase the overall voltage produced by the CSA.

Fuel cell power plants comprise subsystems for the controlled delivering of reactant gases to the anode and cathode electrode catalysts of each fuel cell in a CSA. For example, a fuel processing system (“FPS”) controls the delivery of pressurized hydrogen fuel from a fuel source through a fuel inlet flow path, fuel cell anode flow path, and fuel outlet flow path, and may include a fuel recycle line connecting the fuel outlet flow path to the fuel inlet flow path for recycling unreacted hydrogen back through the stack. Recycling fuel typically enables higher fuel utilization than can be achieved without fuel recycle. For example, with fuel recycle a hydrogen utilization of >95% can be achieved without risk of fuel starvation that can result in performance losses and permanent damage to the cells. To compensate for pressure drop of the hydrogen fuel across the multiple fuel cells in the stack from the fuel inlet flow path to the fuel outlet flow path, a fuel recycle blower is utilized in the fuel recycle line to pressurize the recycled fuel back to an acceptable fuel inlet pressure.

Fuel cell power plants also comprise an air processing system (“APS”) for the controlled delivery of pressurized air through an air inlet flow path, fuel cell cathode flow path, and air outlet flow path. Because air is typically drawn from an atmospheric source, an air blower on the air inlet flow path is utilized to pressurize the air to an acceptable level for supplying an adequate amount of oxygen to each fuel cell cathode catalyst in the stack. A recycle line may also be utilized in the APS connecting the air outlet flow path to the air inlet flow path for recycling unreacted oxygen back through the stack, with an air recycle blower provided on the recycle line to compensate for the pressure drop across the stack. Recycling fuel and/or air can also help prevent membrane dryout near the reactant inlets to the cells, which can lead to premature membrane failure.

Additionally, fuel cell power plants may also comprise a fuel transfer system for selectively permitting the transfer of hydrogen fuel between the FPS and APS to passivate the stack during shutdown and shutoff conditions. During shutdown and shutoff conditions, no electrical load is being powered by the stack, and electrochemical reactions that continue to take place on the anode and cathode catalysts due to residual oxygen and hydrogen remaining in gas diffusion layers, reactant flow fields, ports and manifolds can cause unacceptable and damaging electrical potentials. Therefore, a fuel transfer system is used to passivate the stack using hydrogen gas to displace oxygen and substantially fill both the anode and cathode side of each fuel cell such that almost no electrochemical reactions can occur on either the anode or cathode catalysts. In designing fuel transfer systems and methods, it is desirable to provide the most cost effective, efficient, and lightweight designs suitable for a wide range of applications, including transportation applications.

### SUMMARY

The present disclosure relates to a system and method for passivating a fuel cell with hydrogen fuel utilizing a fuel blower to assist in circulating the hydrogen fuel between and through a fuel processing system and a portion of an air processing system excluding an air blower.

### BRIEF DESCRIPTION OF THE DRAWINGS

FIG. 1 is a schematic representation of a fuel cell power plant, showing an embodiment of the present disclosure.

### DETAILED DESCRIPTION

Disclosed herein is a system and method for passivating a fuel cell stack during shutdown and shutoff conditions that does not require the use of a combustible gas fuel certified air blower. One method of passivating a stack during shutdown is to allow hydrogen fuel to cross into the APS, and use both a fuel recycle blower and an air recycle blower to circulate the hydrogen fuel through the FPS and APS to flush out residual oxygen and nitrogen from gas diffusion layers, reactant flow fields, ports and manifolds. However, this technique requires the air recycle blower to be qualified for the circulation of combustible hydrogen-oxygen mixtures. Typical off-the-shelf air blowers used in fuel cell power plants tend to leak air, for example, where the electrical pigtail comes into the blower, leading to a combustible mixture of hydrogen and oxygen in the APS, in addition to resultant oxidation and corrosion of the fuel cells. Furthermore, off-the-shelf air blowers have exposed circuitry which may cause sparks that can ignite combustible mixtures of gas. To qualify an air blower for handling combustible hydrogen-oxygen mixtures requires custom work to insulate the circuitry of the blower and seal all potential air leaks, leading to a rise in system complexity and component costs.

The system and method of the present disclosure utilizes a fuel recycle blower on a fuel recycle line to assist in circulating hydrogen fuel through the FPS and APS. Because the fuel recycle blower is already certified to handle combustible gases, the cost of certifying an air blower is alleviated. Furthermore, the system and method of the present disclosure offers an efficient and lightweight design generally more suitable for transportation applications than fuel cell power plants requiring a certified air blower and an air recycle line with the valves, plumbing, and control systems associated with this relatively complex APS.

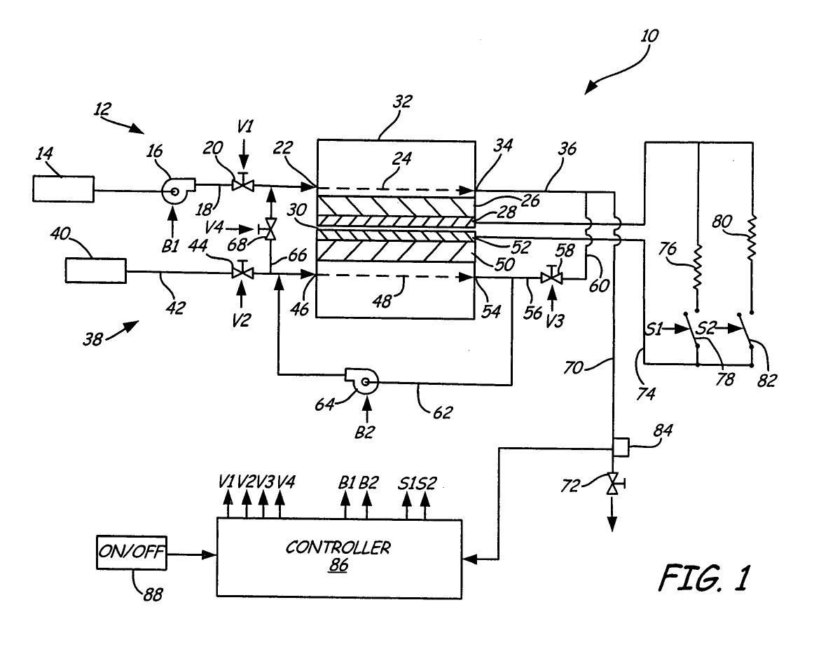

FIG. 1 is a simplified schematic diagram of a fuel cell power plant 10, including APS 12 having oxidant source 14, air blower 16, air feed line 18, air inlet valve 20, cathode air inlet 22, cathode flow field 24, cathode gas diffusion layer 26 adjacent cathode catalyst 28 and electrolyte membrane 30 of fuel cell 32, air outlet 34, and air outlet line 36; and FPS 38 having fuel source 40, fuel feed line 42, fuel inlet valve 44, anode fuel inlet 46, anode flow field 48, anode gas diffusion layer 50 adjacent anode catalyst 52 of fuel cell 32, fuel outlet 54, fuel outlet line 56, fuel exhaust valve 58, outlet transfer line 60, fuel recycle line 62, and fuel recycle blower 64. Further shown are inlet transfer line 66, fuel transfer valve 68, exhaust line 70, exhaust valve 72, external circuit 74, primary load 76, primary load switch 78, auxiliary load 80, auxiliary load switch 82, hydrogen sensor 84, controller 86, and on/off switch 88.

During normal operation of fuel cell power plant 10, primary load switch 78 is closed to electrically connect fuel cell 32 to primary load 76 in external circuit 74, and auxiliary load switch 82 is open to disconnect auxiliary load 80 from fuel cell 32. Only one fuel cell 32 is shown in FIG. 1 for the sake of simplicity, however, it may be appreciated that other quantities and/or configurations of fuel cells are possible under the system and method of the present disclosure. In order to drive an electrochemical reaction across electrolyte membrane 30 to supply a current to external circuit 74 and primary load 76, APS 12 provides oxidant, such as oxygen in atmospheric air, to cathode catalyst 28 while FPS 38 provides fuel, such as hydrogen gas, to anode catalyst 52.

APS 12 functions during operation of power plant 10 by drawing air from oxidant source 14 (e.g., the atmosphere) utilizing air blower 16 to pressurize the air and pass it through air feed line 18 to air inlet valve 20. Air inlet valve 20 is open during operation of power plant 10 to allow pressurized air to enter cathode air inlet 22, which may comprise, for example, manifolds, ports and channels for directing air into cathode flow field 24 of fuel cell 32. Cathode flow field 24 may comprise, for example, channels or porous material, and directs oxidant-containing air to cathode gas diffusion layer 26 for the even distribution of oxidant to cathode catalyst 28. Air is then collected at air outlet 34, which may comprise manifolds, ports and channels for directing exhausted air into air outlet line 36 and exhaust line 70.

FPS 38 functions during operation of power plant 10 by releasing pressurized hydrogen fuel from fuel source 40 into fuel feed line 42. Fuel inlet valve 44 is open during operation of power plant 10 to allow hydrogen fuel to enter anode fuel inlet 46, which may comprise manifolds, ports and channels for directing hydrogen fuel into anode flow field 48 of fuel cell 32. Anode flow field may comprise, for example, channels or porous material, and directs hydrogen fuel to anode gas diffusion layer 50 for the even distribution of hydrogen to anode catalyst 52. Unused fuel is then collected at fuel outlet 54, which may comprise manifolds, ports and channels for directing the unused fuel into fuel outlet line 56. Fuel exhaust valve 58 on fuel outlet line 56 operates to accurately control the quantity of fuel allowed to pass into outlet transfer line 60 and into exhaust line 70 to be mixed with exhausted air. Fuel that does not get exhausted passes into fuel recycle line 62, with fuel recycle blower 64 operating to boost the pressure of the hydrogen fuel prior to entering fuel feed line 42 to be mixed with incoming fresh hydrogen fuel from fuel source 40. Hydrogen fuel recycle is an essential component to most fuel cell power plants because it decreases the amount of wasted hydrogen, thereby increasing the efficiency of the system and decreasing the amount of potentially combustible fuel exhausted to the external environment.

During shutdown of fuel cell power plant 10, primary load switch 78 is first opened to disconnect primary load 76 from fuel cell 32. Air blower 16 is then turned off to stop air flow through air feed line 18, and air inlet valve 20 is closed to prevent encroachment of oxygen from oxidant source 14 into cathode air inlet 22 and cathode flow field 24. Auxiliary load switch 82 is closed to electrically connect fuel cell 32 to auxiliary load 80 in external circuit 74, ensuring that electrochemical cell reactions continue to occur while FPS 28 continues to operate in normal fashion, supplying hydrogen fuel to anode catalyst 52. As electrochemical reactions continue, oxygen remaining in the vicinity of the cathode catalyst 28 of some cells may be consumed, leaving behind predominately atmospheric nitrogen, and some hydrogen will evolve on cathode catalyst 28. However, oxygen will remain in cathode gas diffusion layer 26 and cathode flow field 24, including its associated channels and manifolds. To keep the cells at a relatively low potential for extended periods, it is necessary to further deplete the CSA of residual oxygen.

FIG. 1 further shows a fuel transfer system and method according to the present disclosure for ensuring most, or all, of the remaining oxygen in fuel cell 32, including its associated manifolds, ports, and channels, is removed via the transfer of hydrogen fuel from FPS 38 to APS 12 during shutdown. While FPS 38 continues to operate and air inlet valve 20 remains closed, normally closed fuel transfer valve 68 is opened, allowing hydrogen fuel to transfer from fuel feed line 42 to air feed line 18 via inlet transfer line 66. Furthermore, fuel exhaust valve 58 is opened wide to allow full pass through of gases, including hydrogen fuel and residual air, between fuel outlet line 56 and air outlet line 36. Hydrogen fuel from fuel source 40 continues to be fed through fuel feed line 42, and to ensure proper circulation of hydrogen fuel through both FPS 38 and APS 12, fuel recycle blower 64 continues to operate. If necessary, fuel recycle blower 64 may be controlled to increase its blower speed to provide an adequate boost in pressure to compensate for the increase in pressure drop experienced by hydrogen fuel as it travels through not only FPS 38 but APS 12. Because fuel recycle blower 64 is already certified to handle combustible fuel mixtures, the need to certify an air blower to assist in circulating hydrogen fuel through FPS 38 and APS 12 is eliminated, reducing the cost, weight, and complexity of fuel cell power plant 10. Furthermore, to ensure that hydrogen fuel does not pass through air blower 16, inlet transfer line 66 is positioned downstream of air blower 16 and downstream of closed air inlet valve 20 such that no hydrogen fuel can reach air blower 16.

As hydrogen fuel continues to be circulated to fill up FPS 38 and APS 12, residual oxygen will be pushed into exhaust line 70 and through exhaust valve 72 into the external environment. Exhaust valve 72 is a flapper valve or check valve that is normally closed when power plant 10 is shut down, but opens in response to a positive pressure of exhausted gas in line 70, thereby allowing the exhausted gas to pass through but not allowing the encroachment of atmospheric air back into exhaust line 70.

To signal the final shutoff of fuel cell power plant 10 and FPS 38 such that hydrogen fuel is no longer actively circulated via positive pressure provided by fuel recycle blower 64 and fuel source 40, hydrogen sensor 84 may be used on exhaust line 70 to indicate to controller 86 when an optimal concentration of hydrogen in fuel cell 32, FPS 38, and APS 12 has been reached. When the optimal concentration has been reached, an electrical potential created by each fuel cell is at a level preferably below about 0.4 volts relative to a reference hydrogen electrode (also known as a reversible hydrogen potential), above which harmful oxidation and corrosion of electrode catalyst and catalyst support materials can occur, resulting in attendant cell performance degradation. Rather than employing sensor 84, a timed shutdown could be used to shutoff FPS 38, the requisite amount of time required to reach optimal electrical potential being determined via prior testing and then programmed into the control logic of controller 86. Alternatively, substack voltages could be monitored to indicate when about 0.4 volts or less reversible hydrogen potential has been reached for signaling the final shutoff of fuel cell power plant 10.

Once FPS 38 is shutoff with fuel cell power plant 10, fuel inlet valve 44 is closed to stop hydrogen fuel from feeding into anode fuel inlet 46 on fuel feed line 42, fuel transfer valve 68 is closed, fuel recycle blower 64 is powered off, fuel exhaust valve 58 can be opened or closed, air inlet valve 20 will already be closed and air blower 16 already powered off, and exhaust valve 72 will be checked closed. As the components of fuel cell power plant 10 cool off, hydrogen gas will reduce in volume causing a vacuum to be present in APS 12 and FPS 38. To prevent encroachment of atmospheric oxygen into fuel cell 32 through seals and other potentially leaky components, exhaust valve 72 may be a slightly leaky valve in order to break the vacuum caused by cool down of fuel cell power plant 10. Preferentially, leaky exhaust valve 72 is placed toward the end region of exhaust line 70 to create a larger volume for atmospheric oxygen-containing air to diffuse through before reaching fuel cell 32. Exhaust line 70 may be oriented vertically relative to the ground to ensure that buoyant hydrogen gas present in the line stays nearest fuel cell 32 while oxygen is kept at a safe distance from fuel cell 32 for as long as possible.

Controller 86 operates to control the opening and closing of air inlet valve 20 (with signal V1), fuel inlet valve 44 (with signal V2), fuel exhaust valve 58 (with signal V3), and fuel transfer valve 68 (with signal V4), in addition to the turning on and shutting off of air blower 16 (with signal B1) and fuel recycle blower 64 (with signal B2), and the opening and closing of primary load switch 78 (with signal S1) and auxiliary load switch 82 (with signal S2). Controller 86 may comprise a microprocessor and may be programmed with control logic to ensure the proper coordination and timing of signals V1, V2, V3, V4, B1, B2, S1, and S2 according to the system and method described in the present disclosure. On/off switch 88 may be switched by an operator of power plant 10, for example, and may communicate with controller 86 to indicate when power plant 10 is turned on or shut down. Optionally, hydrogen sensor 84 may be used to signal to controller 86 when power plant 10 may be finally shutoff after the hydrogen passivation shutdown, i.e., when an optimal concentration of hydrogen in fuel cell 32, FPS 42 and APS 12 has been reached.

Although the present invention has been described with reference to preferred embodiments, workers skilled in the art will recognize that changes may be made in form and detail without departing from the spirit and scope of the invention.

1. A method of operating a fuel cell power plant, the method comprising:
operating an air processing system that includes an air blower to deliver oxidant air to a cathode catalyst of a fuel cell;
operating a fuel processing system that includes a fuel blower to deliver hydrogen fuel to an anode catalyst of a fuel cell; and
passivating the fuel cell with hydrogen fuel, comprising:
shutting off the air processing system;
transferring the hydrogen fuel from the fuel processing system to the air processing system; and
using the fuel blower to actively circulate the hydrogen fuel between and through the fuel processing system and a portion of the air processing system excluding the air blower.

2. The method of claim 1, wherein the air processing system does not comprise an air recycle line.

3. The method of claim 2, wherein the hydrogen fuel is transferred from a fuel inlet line of the fuel processing system to an air inlet line of the air processing system.

4. The method of claim 3, wherein the hydrogen fuel is transferred to the air inlet line downstream of an air blower on the air inlet line.

5. The method of claim 4, wherein the hydrogen fuel is also transferred between a fuel outlet line of the fuel processing system and an air outlet line of the air processing system.

6. The method of claim 5, wherein the hydrogen fuel is actively circulated using the fuel blower until an electrochemical potential of at least one of the cathode catalyst and the anode catalyst approach a reversible hydrogen potential.

7. The method of claim 6, wherein the at least one electrochemical potential is about 0.4 volts reversible hydrogen potential or less.

8. A fuel cell having a cathode catalyst and an anode catalyst comprising:
an air processing system for delivering oxidant air to the cathode catalyst of the fuel cell, the air processing system comprising an air inlet line having an air blower positioned on the air inlet line, and an air outlet line;
a fuel processing system for delivering hydrogen fuel to the anode catalyst of the fuel cell, the fuel processing system comprising a fuel inlet line, a fuel outlet line, and a fuel recycle line having a fuel blower and connecting the fuel outlet line to the fuel inlet line;
a fuel transfer system for transferring the hydrogen fuel between the air processing system and the fuel processing system; and
a controller for controlling the fuel processing system, fuel transfer system, and air processing system, and for providing hydrogen passivation of the fuel cell by causing the fuel blower to actively circulate the hydrogen fuel through the fuel processing system, fuel transfer system, and a portion of the air processing system excluding the air blower.

9. The system of claim 8, wherein the air processing system does not comprise an air recycle line connecting the air inlet line to the air outlet line.

10. The system of claim 9, wherein the fuel transfer system comprises an inlet transfer line connecting the fuel inlet line to the air inlet line and an outlet transfer line connecting the fuel outlet line to the air outlet line.

11. The system of claim 10, wherein the inlet transfer line joins the air inlet line downstream of the air blower on the air inlet line.

12. The system of claim 11, wherein the controller provides hydrogen passivation of the fuel cell by causing the fuel blower to actively circulate the hydrogen fuel through the fuel processing system, fuel transfer system, and a portion of the air processing system excluding the air blower until an electrochemical potential of at least one of the cathode catalyst and the anode catalyst approach a reversible hydrogen potential.

13. The system of claim 12, wherein the at least one electrochemical potential is about 0.4 volts reversible hydrogen potential or less.

14. A method of operating a fuel cell power plant, the method comprising:
operating an air processing system that includes an air blower on an air inlet line to deliver oxidant air to a cathode catalyst of a fuel cell;
operating a fuel processing system that includes a fuel blower on a fuel recycle line to deliver hydrogen fuel to an anode catalyst of a fuel cell, the fuel recycle line connecting a fuel outlet line to a fuel inlet line; and
passivating the fuel cell with hydrogen fuel by actively circulating the hydrogen fuel between and through the fuel processing system and a portion of the air processing system excluding the air blower.

15. The method of claim 14, wherein the air processing system does not comprise an air recycle line connecting an air outlet line to the air inlet line.

16. The method of claim 15, wherein the hydrogen fuel is also actively circulated between the fuel outlet line of the fuel processing system and an air outlet line of the air processing system.

17. The method of claim 16, wherein the hydrogen fuel is actively circulated using the fuel blower.

18. The method of claim 17, wherein the hydrogen fuel is actively circulated using the fuel blower until an electrochemical potential of at least one of the cathode catalyst and the anode catalyst approach a reversible hydrogen potential.

19. The method of claim 18, wherein the at least one electrochemical potential is about 0.4 volts reversible hydrogen potential or less.
